(19) United States
(12) Patent Application Publication
(10) Pub. No.: US 2021/0222305 A1
(43) Pub. Date: Jul. 22, 2021

(54) ENERGY TRANSFERRING TYPE PHOTOELECTRODE, MANUFACTURING METHOD FOR THE SAME, AND WATER DECOMPOSITION SYSTEM INCLUDING THE SAME

(71) Applicant: RESEARCH & BUSINESS FOUNDATION SUNGKYUNKWAN UNIVERSITY, Suwon-si (KR)

(72) Inventors: Hyung Koun CHO, Suwon-si (KR); Cheol Hyoun AHN, Suwon-si (KR); Nishad Gopal DESHPANDE, Suwon-si (KR)

(73) Assignee: RESEARCH & BUSINESS FOUNDATION SUNGKYUNKWAN UNIVERSITY, Suwon-si (KR)

(21) Appl. No.: 17/147,685

(22) Filed: Jan. 13, 2021

(30) Foreign Application Priority Data
Jan. 22, 2020 (KR) 10-2020-0008431

(51) Int. Cl. C25B 1/55; C25B 1/04; C25B 11/091

(52) U.S. Cl. CPC C25B 1/55; C25B 11/091; C25B 1/04

(57) ABSTRACT

The present disclosure relates to an energy transferring type photoelectrode including a substrate; a photoactive layer formed on the substrate; and a catalyst layer formed on the photoactive layer, in which an emission spectrum region of the photoactive layer and an absorption spectrum region of the catalyst layer overlap.

### CROSS-REFERENCE TO RELATED APPLICATIONS

This application claims the benefit under 35 USC 119(a) of Korean Patent Application No. 10-2020-0008431 filed on Jan. 22, 2020, in the Korean Intellectual Property Office, the disclosure of which is incorporated herein by reference.

### BACKGROUND

### 1. Field

The present disclosure relates to an energy transferring type photoelectrode, a manufacturing method for the same, and a water decomposition system including the same.

### 2. Description of Related Art

It has been known that when fossil fuels such as petroleum and coal are burned for the purpose of electric energy or transportation, carbon dioxide and methane are generated, which have a large impact on environmental pollution or global warming. In order to solve the above-mentioned problem, various alternative energy sources such as hydrogen energy or solar energy are being studied.

The hydrogen energy that attracts attention as an alternative energy source is mainly obtained by a process of thermally decomposing gas generated from fossil fuels, but it has a problem in that carbon dioxide generated from this process needs to be treated. Even though in order to solve the above-mentioned problems, a water decomposition process that decomposes water into hydrogen and oxygen has been proposed, a catalyst for lowering the energy for a water decomposition reaction needs to be developed.

Hydrogen obtained from the water decomposition reaction may be utilized for a fuel cell that acquires electric energy by means of the reaction of hydrogen and oxygen and may be expected to be utilized as a renewable energy source in various fields, such as hydrogen cars which utilize hydrogen as an energy source. Hydrogen energy is attracting attention as an eco-friendly energy source because harmful gasses generated from the existing fossil fuels are not generated in the reaction for acquiring the power.

However, there is a disadvantage in that the water decomposition reaction for acquiring hydrogen requires a lot of energy. Therefore, in order to commercialize hydrogen energy, a catalyst for efficiently producing hydrogen and a catalyst for reducing the energy required for the reaction of hydrogen and oxygen are essential.

Catalysts available for water decomposition may include a platinum catalyst or a non-metallic catalyst. The non-metallic catalyst has superior price competitiveness to the platinum catalyst, but there is a problem in that a high energy is required for the oxidation and reduction reaction of water. Further, the platinum catalyst may increase the efficiency of the oxygen reduction reaction or the hydrogen evolution reaction, but there is a problem in that it is difficult to commercialize the platinum catalyst due to the usage of expensive platinum. In order to overcome the above-described problems, catalysts that achieve efficiency comparable to that of the platinum catalyst at low prices are being studied.

As support for such a catalyst, metal-organic frameworks (MOF) having a porous structure are attracting attention. The metal-organic frameworks refer to organic/inorganic hybrid materials with a one-dimensional, two-dimensional, or three-dimensional structure formed by coordinating metal ions or ionic clusters to organic molecules. In this case, the MOF has various chemical properties to be used as a catalyst for the reaction of producing hydrogen or producing water and electric energy.

The paper (Cardenas-Morcoso, Drialys, et al. “A Metalorganic Framework Converted Catalyst That Boosts Photo-Electrochemical Water Splitting.” Journal of Materials Chemistry A, vol. 7, no. 18, 2019, pp. 11143 to 11149) which is the background of the present disclosure relates to a catalyst which is capable of decomposing water using the MOF. However, according to the paper, only CoOₓ obtained by thermally treating BiVO₄ and ZIF-67 is used for the oxygen evolution reaction, but a catalyst which uses only BiVO₄ and ZIF-67 has not been mentioned.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an energy transferring type photoelectrode, includes a substrate, a photoactive layer formed on the substrate, and a catalyst layer formed on the photoactive layer. An emission spectrum region of the photoactive layer and an absorption spectrum region of the catalyst layer overlap.

Holes, electrons, or energy generated from the photoactive layer may be transmitted to the catalyst layer.

A catalyst performance of the catalyst layer may be improved by the holes, the electrons, or the energy.

The catalyst layer may have a porous structure.

The catalyst layer may include pores of 1 nm or less.

The photoactive layer may include one selected from the group consisting of BiVO₄, Cu₂O, TiO₂, Fe₂O₃, WO₃, MoS₂, MoSe₂, MoTe₂, WS₂, WSe₂, WTe₂, SnS₂, SnSe₂, SnTe₂, ReS₂, ReSe₂, ReTe₂, TaS₂, TaSe₂, TaTe₂, TiS₂, TiSe₂, TiTe₂, and a combination thereof.

The catalyst layer may include one selected from the group consisting of a metal-organic framework (MOF), a zeolitic-imidazolate framework (ZIF), zeolite, and a combination thereof.

The substrate may include one selected from the group consisting of FTO, ITO, Si, SIO₂, Ge, SiGe, SiC, InAs, AlAs, GaAs, InP, GaN, InGaAs, InAlAs, GaSb, AlSb, AlP, GaP, and a combination thereof.

A water decomposition system may include the energy transferring type photoelectrode of above.

In another general aspect, a manufacturing method of an energy transferring type photoelectrode, includes forming a photoactive layer on a substrate, and forming a catalyst layer on the photoactive layer.

The manufacturing method of the energy transferring type photoelectrode may not include thermal treating after the forming of the catalyst layer.

The forming of a catalyst layer may include forming a metal-organic framework (MOF) or a zeolitic-imidazolate framework (ZIF) by thermally treating an MOF precursor or a ZIP precursor; and transferring or coating the MOF or the ZIF onto the photoactive layer.

The MOF precursor or the ZIF precursor may independently include a precursor of a metal ion consisting of Co, Ti, Zn, Cd, Zr, Hf, and a combination thereof, and an organic precursor or an imidazolate precursor.

The forming of a photoactive layer may be performed by a process including one selected from the group consisting of a sol-gel process, spin coating, bar coating, nozzle printing, spray coating, slot die coating, gravure printing, inkjet printing, screen printing, electrohydrodynamic jet printing, electrospray, and a combination thereof.

Other features and aspects will be apparent from the following detailed description, the drawings, and the claims.

### BRIEF DESCRIPTION OF THE DRAWINGS

FIG. 1 is a diagram of an energy transferring type photoelectrode according to an implementation example of the present disclosure.

FIG. 2 is a graph illustrating a condition of a photoactive layer and a catalyst layer according to an implementation example of the present disclosure.

FIG. 3 is a mechanism of a water decomposition system according to an implementation example of the present disclosure.

FIG. 4 is a mechanism of an energy transferring type photoelectrode according to an implementation example of the present disclosure.

FIG. 5 is a mechanism of a photocatalyst of the related art.

FIG. 6 is an SEM image of an energy transferring type photoelectrode according to an embodiment of the present disclosure.

FIG. 7 is a partial spectrum of an energy transferring type photoelectrode according to an embodiment of the present disclosure.

FIG. 8 is a graph illustrating a water decomposition reaction of an energy transferring type photoelectrode according to an embodiment of the present disclosure and a photocatalyst according to a comparative example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

The terms “about or approximately” or “substantially” indicating a degree used throughout the specification are used as a numerical value or a meaning close to the numerical value when a unique manufacturing and material tolerance is proposed to the mentioned meaning and also used to prevent unscrupulous infringers from wrongfully using the disclosure in which precise or absolute numerical values are mentioned for better understanding of the present disclosure. Terms used throughout the specification, “˜step of ˜ing” or “step of˜” do not mean “step for˜”.

Throughout the specification of the present disclosure, the term “combination thereof” included in the expression of Markushi format refers to a mixture or a combination of one or more selected from a group consisting of components described in the expression of the Markushi format and it means that one or more selected from the group consisting of the components is included.

Throughout the specification of the present disclosure, the description of “A and/or B” refers to “A or B” or “A and B”.

Throughout the specification of the present disclosure, “organic materials” refer to organic materials used for a normal MOF structure or ZIF structure and specifically, refer to materials including one or more functional groups which form two or more coordination bonds to a metal oxide cluster or metal oxide particles or form one coordination bond to each of two or more metal oxide clusters or the metal oxide particles.

Hereinafter, the electrochemical catalyst and a producing method thereof according to the present disclosure will be described in detail with reference to implementation examples, embodiments, and drawings. However, the present disclosure is not limited to the implementation examples, the embodiments, and the drawings.

An object to be achieved by the present disclosure is to solve the above-described problems of the related art and to provide an energy transferring type photoelectrode and a manufacturing method for the same.

Further, another object to be achieved by the present disclosure is to provide a water decomposition system including the energy transferring type photoelectrode.

As a technical means to achieve the above-described technical object, a first aspect of the present disclosure provides an energy transferring type photoelectrode 10, which includes a substrate 100, a photoactive layer 200 formed on the substrate 100, and a catalyst layer 300 formed on the photoactive layer 200. An emission spectrum region of the photoactive layer 200 and an absorption spectrum region of the catalyst layer 300 overlap each other.

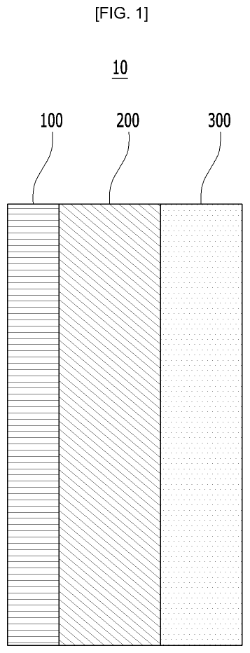

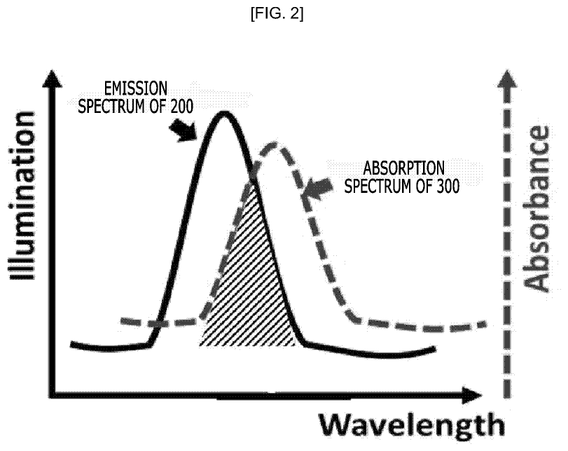

FIG. 1 is a diagram of an energy transferring type photoelectrode according to an implementation example of the present disclosure, and FIG. 2 is a graph illustrating a condition of a photoactive layer and a catalyst layer according to an implementation example of the present disclosure.

According to an implementation example of the present disclosure, holes, electrons, or energy generated from the photoactive layer 200 may be transmitted to the catalyst layer 300, but is not limited thereto.

Desirably, the holes, the electrons, and energy may be simultaneously generated from the photoactive layer, and the energy may be emitted in the form of photons, but is not limited thereto.

When the photoactive layer of the photocatalyst of the related art and the photoactive layer 200 of the energy transferring type photoelectrode 10 according to the present disclosure receive light, photons, holes, or electrons having energy with a predetermined wavelength are generated to allow the photoactive layers to function as catalysts. However, the photons generated from the photocatalyst of the related art are consumed without having a catalytic performance, and the holes or electrons have a property of being recombined so that there is a problem in that a smooth catalytic reaction appears only when a high voltage is applied.

Unlike the photocatalyst of the related art, the energy transferring type photoelectrode 10 according to the present disclosure includes the catalyst layer 300, which has a catalytic performance by the holes, electrons, and photons generated from the photoactive layer 200 and the catalyst layer 300 may function as a catalyst using the photons. Therefore, the catalytic efficiency of the energy transferring type photoelectrode 10 may be improved as compared with the photocatalyst of the related art.

Specifically, referring to FIG. 2, when light is irradiated onto the energy transferring type photoelectrode 10, the photoactive layer 200 has an emission spectrum by the light, and the catalyst layer 300 may have an absorption spectrum that absorbs the light. With regard to this, when the emission spectrum of the photoactive layer 200 and the absorption spectrum of the catalyst layer 300 overlap, the catalyst layer 300 may have a function as a catalyst not only by the light, but also by light emitted from the photoactive layer 200 so that the catalytic performance may be improved more than the photocatalyst of the related art.

According to an implementation example, an overlapping degree may be 10% to 90%, but is not limited thereto. For example, the overlapping degree may be approximately 10% to 90%, approximately 20% to approximately 90%, approximately 30% to approximately 90%, approximately 40% to approximately 90%, approximately 50% to approximately 90%, approximately 60% to approximately 90%, approximately 70% to approximately 90%, approximately 80% to approximately 90%, approximately 10% to approximately 20%, approximately 10% to approximately 30%, approximately 10% to approximately 40%, approximately 10% to approximately 50%, approximately 10% to approximately 60%, approximately 10% to approximately 70%, approximately 10% to approximately 80%, approximately 20% to approximately 80%, approximately 30% to approximately 70%, approximately 40% to approximately 60%, or approximately 50%, but is not limited thereto.

The area where the emission spectrum of the photoactive layer 200 and the absorption spectrum of the catalyst layer 300 overlap means that light generated from the photoactive layer 200 may be absorbed onto the catalyst layer 300. With regard to this, the larger the overlapping degree of the emission spectrum of the photoactive layer 200 and the absorption spectrum of the catalyst layer 300, the better the catalytic performance of the catalyst layer 300. Therefore, the water decomposition system, including the energy transferring type photoelectrode 10 according to the present disclosure, may have a higher energy applicability than that of the water decomposition system of the related art.

According to an implementation example, a range of the wavelength of the emission spectrum of the photoactive layer 200 and the absorption spectrum of the catalyst layer 300 may be independently 300 nm to 1000 nm, but is not limited thereto. For example, the range of the wavelength of the emission spectrum of the photoactive layer 200 and the absorption spectrum of the catalyst layer 300 may be independently approximately 300 nm to approximately 1,000 nm, approximately 350 nm to approximately 1,000 nm, approximately 400 nm to approximately 1,000 nm, approximately 450 nm to approximately 1,000 nm, approximately 500 nm to approximately 1,000 nm, approximately 550 nm to approximately 1,000 nm, approximately 600 nm to approximately 1,000 nm, approximately 650 nm to approximately 1,000 nm, approximately 700 nm to approximately 1,000 nm, approximately 750 nm to approximately 1,000 nm, approximately 800 nm to approximately 1,000 nm, approximately 850 nm to approximately 1,000 nm, approximately 900 nm to approximately 1,000 nm, approximately 300 nm to approximately 350 nm, approximately 300 nm to approximately 400 nm, approximately 300 nm to approximately 450 nm, approximately 300 nm to approximately 500 nm, approximately 300 nm to approximately 550 nm, approximately 300 nm to approximately 600 nm, approximately 300 nm to approximately 650 nm, approximately 300 nm to approximately 700 nm, approximately 300 nm to approximately 750 nm, approximately 300 nm to approximately 800 nm, approximately 300 nm to approximately 850 nm, approximately 300 nm to approximately 900 nm, approximately 350 nm to approximately 900 nm, approximately 400 nm to approximately 850 nm, approximately 450 nm to approximately 800 nm, approximately 500 nm to approximately 750 nm, approximately 550 nm to approximately 700 nm, or approximately 600 nm to approximately 650 nm, but is not limited thereto.

Desirably, in order to prepare the energy transferring type photoelectrode 10 to be used for the water decomposition system to be described below, the range of the wavelength of the emission spectrum of the photoactive layer 200 and the absorption spectrum of the catalyst layer 300 may be a visible ray region or an infrared ray region.

According to an implementation example of the present disclosure, the catalytic performance of the catalyst layer 300 may be improved by holes, electrons, or energy, but is not limited thereto.

According to an implementation example of the present disclosure, the photoactive layer 200 may include one selected from a group consisting of BiVO₄, Cu₂O, TiO₂, Fe₂O₃, WO₃, MoS₂, MoSe₂, MoTe₂, WS₂, WSe₂, WTe₂, SnS₂, SnSe₂, SnTe₂, ReS₂, ReSe₂, ReTe₂, TaS₂, TaSe₂, TaTe₂, TiS₂, TiSe₂, TiTe₂, and a combination thereof, but is not limited thereto.

The photoactive layer 200, according to the present disclosure, is a material that receives light to emit energy, holes, or electrons in the form of light and is also referred to as a photoelectrode. The photoactive layer 200 may decompose water (H₂O) to form oxygen (O₂), but is not limited thereto.

The photoactive layer 200 may adjust a bandgap in accordance with a crystal structure and/or a wavelength of irradiated light. As the bandgap of the photoactive layer 200 is decreased, a water decomposition performance or an oxygen evolution rate of the energy transferring type photoelectrode 10 may be improved. In order to reduce the bandgap, the photoactive layer 200 may be doped with a metal, but is not limited thereto.

According to an implementation example of the present disclosure, the catalyst layer 300 may include one selected from a group consisting of a metal-organic framework (MOF), a zeolitic-imidazolate framework (ZIF), zeolite, and a composition thereof, but is not limited thereto.

The metal-organic framework (MOF), according to the present disclosure, refers to an organic-inorganic hybrid material in which metal ions or ion clusters are coordinated with organic material. The zeolitic-imidazolate framework (ZIF) is a kind of MOF and has a similar structure to zeolite. Since the catalyst layer 300 has a porous structure, the water molecules may pass through the catalyst layer 300 to be decomposed by the photoactive layer 200.

With regard to this, the MOF and the ZIF may have innumerable combinations depending on the type of metal and organic materials, and the MOF and the ZIF may include a material selected from a group consisting of Co, Ti, Zn, Cd, Zr, Hf, and a combination thereof, but is not limited thereto.

For example, the MOF or the ZIF may include Co-based ZIF-67, Ti-based MIL-125, Zn-based MOF-5, IRMOF-8, Zn-PDA2, and Zn-PDA1, Cd-based Cd-TCAA, or Zr-based UiO-67, but is not limited thereto.

With regard to this, the photoactive layer 200 and the catalyst layer 300 may function as a catalyst of not only a hydrogen evolution reaction and an oxygen evolution reaction, but also various reactions such as a CO oxidation reaction, a CO₂ reduction reaction, an NH₃ production reaction, and an H₂O₂ production reaction.

For example, the photoactive layer 200 is BiVO₄, oxygen may be evolved from the energy transferring type photoelectrode 10, and hydrogen may be evolved from a counter electrode of the photoelectrode 10.

According to an implementation example of the present disclosure, the catalyst layer 300 may have a porous structure, but it is not limited thereto.

According to an implementation example of the present disclosure, the catalyst layer 300 may include pores of 1 nm or less, but it is not limited thereto. For example, the catalyst layer 300 may include pores of approximately 1 nm or less, approximately 0.9 nm or less, approximately 0.8 nm or less, approximately 0.7 nm or less, approximately 0.6 nm or less, approximately 0.5 nm or less, approximately 0.4 nm or less, approximately 0.3 nm or less, approximately 0.2 nm or less, or approximately 0.1 nm or less, but is not limited thereto. Desirably, the catalyst layer 300 may have pores of 0.3 nm or larger to allow the water molecules (0.275 nm) and oxygen molecule (0.296 nm) to pass therethrough.

The catalyst layer 300, according to the present disclosure, may include a porous material having an MOF or ZIF structure and decompose the water through holes, electrons, or energy transmitted from the photoactive layer 200.

With regard to this, in order to improve the efficiency of the water decomposition reaction of the porous material, the catalyst layer 300 or the photoactive layer 200 may include a porous material doped with metal, a thermally treated porous material, or a porous material which is not thermally treated. Desirably, the photoactive layer 200 and the catalyst layer 300 may include a porous material that is not thermally treated.

The porous material doped with a metal may be provided such that a noble metal or a transition metal is substituted or doped with a metal component of the MOF or the ZIF or adsorbed onto the outside of the metal of the MOF or the ZIF.

With regard to this, the noble metal may be selected from a group consisting of Ir, Ru, Os, Rh, Pt, Pd, Au, Ag, and a combination thereof, but is not limited thereto.

According to an implementation example of the present disclosure, the noble metal may reduce H⁺ ions to produce H₂, but is not limited thereto.

The noble metal may be solely used to reduce H⁺ ions to form a hydrogen molecule. In order to maximize a surface area of the noble metal, when the noble metal is dispersed in the form of particles, particles of the noble metal are bonded to each other, which may degrade the hydrogen evolution efficiency. However, when the noble metal is adsorbed onto the surface of the metal component of the MOF or the ZIF, the metal and the noble metal are strongly bonded by a strong metal support interaction (SMSI) effect to solve the binding problem of the noble metal.

Specifically, when the noble metal or the catalyst layer 300, including the noble metal, is immersed in an acid solution, H⁺ ions on the surface of the noble metal are bond with the water molecules to form H₃O⁺ ions. H₃O⁺ reacts with the noble metal to be reduced to hydrogen, and this process is referred to as hydrogen reverse spillover.

According to an implementation example of the present disclosure, the transition metal may include one selected from a group consisting of Fe, Mn, Co, Ni, Cu, and a combination thereof, but is not limited thereto.

The transition metal oxidizes the hydrogen to produce water and electric energy, but is not limited thereto.

According to an implementation example of the present disclosure, the substrate 100 may be transparent, and for example, may include one selected from a group consisting of FTO, ITO, Si, SIO₂, Ge, SiGe, SiC, InAs, AlAs, GaAs, InP, GaN, InGaAs, InAlAs, GaSb, AlSb, AlP, GaP, and a combination thereof, but is not limited thereto.

The substrate 100, according to the present disclosure, may refer to a space that is capable of collecting electrons generated from the photoactive layer 200. With regard to this, when light is irradiated onto the photoactive layer 200, the photoactive layer 200 may emit photons according to an emission spectrum. The catalyst layer 300 absorbs the photons and may generate electrons and holes. The electrons move to the substrate 100 via the photoactive layer 200 and flow into the counter electrode along a circuit to react with the electrolyte to evolve hydrogen, and the holes move to the catalyst layer 300 and then react with the electrolyte to evolve oxygen.

With regard to this, the light irradiated onto the energy transferring type photoelectrode 10 needs to pass through the substrate 100 and reach the photoactive layer 200 or the catalyst layer 300 so that the substrate 100 may be transparent.

According to an implementation example, the electrolyte may include sulfur ions (S²⁻) or sulfate ions (SO₄²⁻), but is not limited thereto.

According to an implementation example, the energy transferring type photoelectrode 10 may further include a support layer on a lower end of the substrate 100, such as a glass substrate, but is not limited thereto.

As will be described below, the energy transferring type photoelectrode 10 may be used for a water decomposition system that decomposes water to evolve oxygen and hydrogen.

A second aspect of the present disclosure provides a manufacturing method of an energy transferring type photoelectrode 10, including an operation of forming a photoactive layer 200 on the substrate 100 and an operation of forming a catalyst layer 300 on the photoactive layer 200.

A detailed description of repeated parts of the energy transferring type photoelectrode 10 according to the second aspect of the present disclosure with the first aspect of the present disclosure will be omitted. However, even though the detailed description thereof is omitted, the description of the first aspect of the present disclosure may be applied to the second aspect of the present disclosure in the same manner.

According to an implementation example of the present disclosure, the manufacturing method of the energy transferring type photoelectrode 10 may not include a thermal-treatment operation after forming the catalyst layer 300, but it is not limited thereto.

As described above, the catalyst layer 300 may include a porous material. With regard to this, the porous material may include an MOF or ZIP material. When the porous material is thermally treated, organic material of the porous material is decomposed by the heat to form metal ion clusters, but the photoactive layer 200 may have defected.

Since the manufacturing method of an energy transferring type photoelectrode 10 according to the present disclosure does not include a thermal treatment process, the photoactive layer 200 and the catalyst layer 300 may decompose water, which means that the energy transferring type photoelectrode 10 has an excellent water decomposition performance as compared with the photocatalyst of the related art manufactured by a method including a thermal treatment process.

First, the photoactive layer 200 is formed on the substrate 100.

According to an implementation example of the present disclosure, the operation of forming a photoactive layer 200 may be performed by a process including one selected from a group consisting of a sol-gel process, spin coating, bar coating, nozzle printing, spray coating, slot die coating, gravure printing, inkjet printing, screen printing, electrohydrodynamic jet printing, electrospray, and a combination thereof, but is not limited thereto.

Next, the catalyst layer 300 is formed on the photoactive layer 200.

According to an implementation example of the present disclosure, the operation of forming a catalyst layer 300 may include an operation of forming an MOF or a ZIF by thermally treating an MOF precursor or a ZIF precursor and an operation of transferring or coating the MOF or the ZIF onto the photoactive layer, but is not limited thereto.

According to an implementation example of the present disclosure, the MOF precursor or the ZIF precursor may independently include a precursor of a metal ion consisting of Co, Ti, Zn, Cd, Zr, Hf, and a combination thereof, and an organic precursor or an imidazolate precursor, but is not limited thereto.

For example, the MOF precursor or the ZIF precursor may include a precursor of the metal ion, the organic precursor, or the precursor of the metal ion and an imidazolate precursor, but is not limited thereto.

With regard to this, the operation of forming the MOF or the ZIF may be performed in the other space, rather than an upper end of the photoactive layer 200. The operation of transferring or coating the MOF or the ZIF may be performed by the same method or different method from the operation of forming a photoactive layer 200.

A third aspect of the present disclosure provides a water decomposition system, including the energy transferring type photoelectrode 10 according to the first aspect.

A detailed description of repeated parts of the water decomposition system according to the third aspect of the present disclosure with the first aspect and/or the second aspect of the present disclosure will be omitted. However, even though the detailed description thereof is omitted, the description of the first aspect and/or the second aspect of the present disclosure may be applied to the third aspect of the present disclosure in the same manner.

The water decomposition system, according to the present disclosure, starts from an operation of irradiating light onto the energy transferring type photoelectrode 10. When light is irradiated onto the energy transferring type photoelectrode 10, water is decomposed between the photoactive layer 200 and the electrolyte (not illustrated) to form oxygen, and simultaneously, light, electrons, or holes generated from the photoactive layer 200 move to the catalyst layer 300 so that a catalytic reaction may be generated between the catalyst layer 300 and the electrolyte.

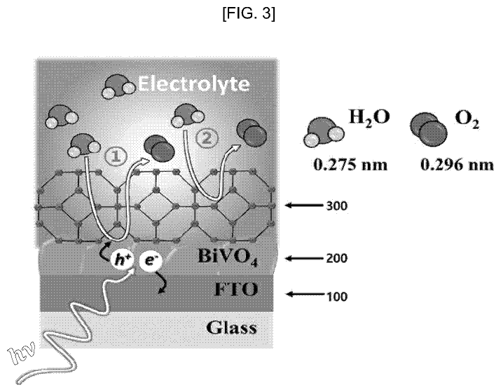

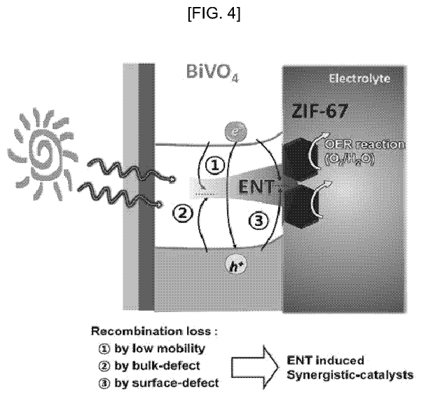

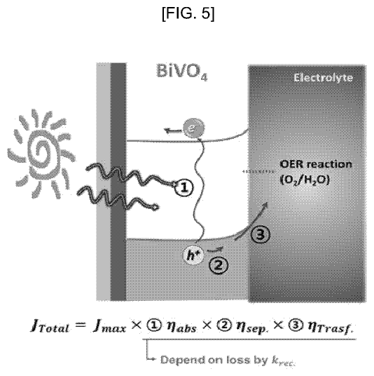

FIG. 3 is a mechanism of a water decomposition system according to an implementation example of the present disclosure, FIG. 4 is a mechanism of an energy transferring type photoelectrode 10 according to an implementation example of the present disclosure, and FIG. 5 is a mechanism of a photocatalyst of the related art.

Referring to FIGS. 3 to 5, when light hv is irradiated onto the photoactive layer 200 of the energy transferring type photoelectrode 10, electrons e⁻ generated from the photoactive layer 200 move to the substrate 100, and holes h⁺ move to the catalyst layer 300. The electrolyte, which is in contact with the energy transferring type photoelectrode 10 reacts with the photoactive layer 200 to evolve oxygen, and the catalyst layer 300 absorbs light generated from the photoactive layer 200 to generate electrons and holes. The holes react with the electrolyte to further evolve oxygen so that the water decomposition performance of the energy transferring type photoelectrode 10 may be improved as compared with the photocatalyst of the related art.

A degree of the oxygen evolution reaction in the photocatalyst of the related art and the energy transferring type photoelectrode 10 according to the present disclosure is proportional to a magnitude of a current density acquired by the following Equation 1.

Jₜₒₜₐₗ=Jₘₐₓ×η_{abs}×ηₛₑₚ×η_{transf} [Equation 1]

With regard to this, the η_{abs} refers to a desulfurization efficiency, the ηₛₑₚ refers to an electron-hole separation efficiency, and the η_{transf} refers to a charge transfer efficiency. The photocatalyst of the related art does not include the catalyst layer 300 so that a recombination rate of the electrons and the holes is high, and the holes may not move to the electrolyte. Therefore, the water may not be efficiently decomposed.

Further, the degree that the catalyst layer 300 absorbs light or energy generated from the photoactive layer 200 is referred to as excitonic energy transfer (ENT). The larger the degree of overlapping the emission spectrum region of the photoactive layer 200 and the absorption spectrum region of the catalyst layer 300, the larger the ENT.

However, for example, in the energy transferring type photoelectrode 10, according to the present disclosure, when the photoactive layer 200 is BiVO₄ and the catalyst layer 300 is ZIF-67, if light is irradiated onto the photoelectrode, in the BiVO₄, electrons and holes are separated and energy is emitted. In this case, if BiVO₄ is adjacent to ZIF-67, the electrons and the holes have a low recombination rate due to low mobility, a bulk-defect of BiVO₄, and a surface-defect so that the water decomposition performance may be improved.

Hereinafter, the present disclosure will be described in more detail with respect to examples, but the following examples are set forth to illustrate, but are not to be construed to limit the scope of the present disclosure.

### Example

As an example of the present disclosure, a glass substrate coated with FTO was cleansed first with acetone, ethanol, and DI in this order by utilizing sonicate and was dried in an oven. A precursor prepared by dissolving 200 mg of ethyl cellulose in 50 mM of Bi(NO₃)₃.5H₂O, 46.5 mM of C₁₀H₁₄O₅V, and acetic acid was spin-coated on the dried substrate at 2000 rpm, and then soft-baked for 30 minutes at 450° C. In order to form a thin film with a thickness of 100 nm, the spin coating and the soft-baking were repeatedly performed, and then finally, thermal-treatment was performed for two hours at 450° C. to synthesize BiVO₄.

Next, in order to synthesize ZIF-67 on the BiVO₄ thin film, BiVO₄/FTO/Glass was immersed in a solution obtained by dissolving 20 mM Co(NO₃)₂, and 40 mM 2-methylimidazolte cobalt nitrate hexahydrate in methanol for six hours or longer at a room temperature. Next, a ZIF-67/BiVO₄/FTO/Glass sample was cleansed several times with methanol and then dried in an oven at 70° C. for 24 hours to prepare a sample.

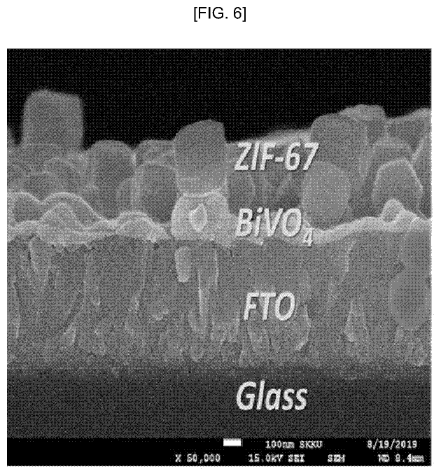

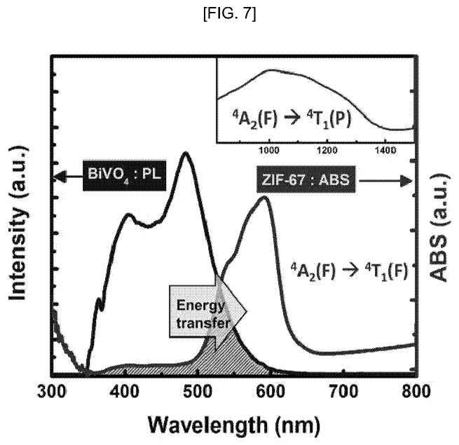

FIG. 6 is an SEM image of an energy transferring type photoelectrode according to the example of the present disclosure. FIG. 7 is a partial spectrum of an energy transferring type photoelectrode according to the example.

Referring to FIG. 7, an emission spectrum of BiVO₄ and the absorption spectrum of ZIF-67 partially overlap. In this case, it is confirmed that an absorption spectrum due to ⁴A₂(F)-⁴T₁(F) transition in a visible ray region and an absorption spectrum due to ⁴A₂(F)-⁴T₁(p) transition in an infrared region are generated as d-d transition phenomenon of cobalt of ZIP-67. It is further confirmed that the absorption spectrum in the visible ray region overlaps a BiVO₄ emission spectrum. Accordingly, it is confirmed that an energy transferring phenomenon that energy by the recombination generated in the BiVO₄ layer, which is a photoactive layer is absorbed by the ZIF-67 material may be effectively generated, and the ZIF-67 absorbs an energy loss to efficiently decompose the water by the water decomposition reaction.

### Comparative Example

The same process as the above example was performed, but a photocatalyst in which ZIP-67 was not formed on BiVO₄ was produced.

### Experimental Example 1

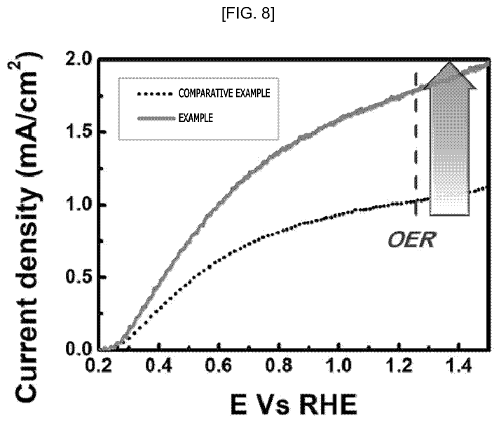

FIG. 8 is a graph illustrating a water decomposition reaction of an energy transferring type photoelectrode according to the example and a photocatalyst according to the comparative example.

Referring to FIG. 8, it is confirmed that the energy transferring type photoelectrode has a higher current density than that of the photocatalyst so that a water decomposition efficiency more excellent than that of the photocatalyst of the related art may be achieved.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An energy transferring type photoelectrode, comprising:
a substrate;
a photoactive layer formed on the substrate; and
a catalyst layer formed on the photoactive layer,
wherein an emission spectrum region of the photoactive layer and an absorption spectrum region of the catalyst layer overlap.

2. The energy transferring type photoelectrode of claim 1, wherein holes, electrons, or energy generated from the photoactive layer are transmitted to the catalyst layer.

3. The energy transferring type photoelectrode of claim 2, wherein a catalyst performance of the catalyst layer is improved by the holes, the electrons, or the energy.

4. The energy transferring type photoelectrode of claim 1, wherein the catalyst layer has a porous structure.

5. The energy transferring type photoelectrode of claim 4, wherein the catalyst layer includes pores of 1 nm or less.

6. The energy transferring type photoelectrode of claim 1, wherein the photoactive layer includes one selected from the group consisting of BiVO₄, Cu₂O, TiO₂, Fe₂O₃, WO₃, MoS₂, MoSe₂, MoTe₂, WS₂, WSe₂, WTe₂, SnS₂, SnSe₂, SnTe₂, ReS₂, ReSe₂, ReTe₂, TaS₂, TaSe₂, TaTe₂, TiS₂, TiSe₂, TiTe₂, and a combination thereof.

7. The energy transferring type photoelectrode of claim 1, wherein the catalyst layer includes one selected from the group consisting of a metal-organic framework (MOF), a zeolitic-imidazolate framework (ZIF), zeolite, and a combination thereof.

8. The energy transferring type photoelectrode of claim 1, wherein the substrate includes one selected from the group consisting of FTO, ITO, Si, SIO₂, Ge, SiGe, SiC, InAs, AlAs, GaAs, InP, GaN, InGaAs, InAlAs, GaSb, AlSb, AlP, GaP, and a combination thereof.

9. A water decomposition system including the energy transferring type photoelectrode of claim 1.

10. A water decomposition system including the energy transferring type photoelectrode of claim 2.

11. A water decomposition system including the energy transferring type photoelectrode of claim 3.

12. A water decomposition system including the energy transferring type photoelectrode of claim 4.

13. A water decomposition system including the energy transferring type photoelectrode of claim 5.

14. A water decomposition system including the energy transferring type photoelectrode of claim 6.

15. A water decomposition system including the energy transferring type photoelectrode of claim 7.

16. A manufacturing method of an energy transferring type photoelectrode, comprising:
forming a photoactive layer on a substrate; and
forming a catalyst layer on the photoactive layer.

17. The manufacturing method of claim 16, wherein the manufacturing method of the energy transferring type photoelectrode does not include thermal treating after the forming of the catalyst layer.

18. The manufacturing method of claim 16, wherein the forming of a catalyst layer includes
forming a metal-organic framework (MOF) or a zeolitic-imidazolate framework (ZIF) by thermally treating an MOF precursor or a ZIP precursor; and transferring or coating the MOF or the ZIF onto the photoactive layer.

19. The manufacturing method of claim 18, wherein the MOF precursor or the ZIF precursor independently includes a precursor of a metal ion consisting of Co, Ti, Zn, Cd, Zr, Hf, and a combination thereof, and an organic precursor or an imidazolate precursor.

20. The manufacturing method of claim 16, wherein the forming of a photoactive layer is performed by a process including one selected from the group consisting of a sol-gel process, spin coating, bar coating, nozzle printing, spray coating, slot die coating, gravure printing, inkjet printing, screen printing, electrohydrodynamic jet printing, electrospray, and a combination thereof.
